(19) United States
(12) Patent Application Publication
(10) Pub. No.: US 2007/0038945 A1
(43) Pub. Date: Feb. 15, 2007

(54) System and method allowing one computer system user to guide another computer system user through a remote environment

(76) Inventors: Jacob James Miller, Hillsdale, MI (US); Jean-Alfred Ligeti, British Columbia (CA)

Correspondence Address: LAW OFFICES OF ERIC KARICH, 2807 ST. MARK DR., MANSFIELD, TX, 76063, US

(21) Appl. No.: 11/201,880

(22) Filed: Aug. 10, 2005

(51) Int. Cl. G06F 9/00

(52) U.S. Cl. 715/760

(57) ABSTRACT

A system for enabling an agent to guide a client through a remote environment has an agent computer system that receives input from the agent. The system uses the input to generate a remote navigation instruction, and provides the remote navigation instruction to a server computer system via a communication network. The remote navigation instruction is indicative of directions of motion and view selected by the agent. The server computer system receives and stores the remote navigation instruction. A client computer system obtains the remote navigation instruction from the server computer system, uses the remote navigation instruction to select image data, and displays an image on a display screen such that the client, when viewing the display screen, experiences a perception of movement through the remote environment in the direction of motion selected by the agent and while looking in the direction of view selected by the agent.

### CROSS-REFERENCE TO RELATED APPLICATIONS

This application relates to co-pending U.S. patent application Ser. No. 11/056,935, entitled “METHODS FOR SIMULATING MOVEMENT OF A COMPUTER USER THROUGH A REMOTE ENVIRONMENT,” filed Feb. 11, 2005.

### BACKGROUND OF THE INVENTION

1. Field of the Invention

This invention relates generally to virtual reality technology, and more particularly to systems and methods for simulating movement of a user through a remote or virtual environment.

2. Description of Related Art

Virtual reality technology is becoming more common, and several methods for capturing and providing virtual reality images to users already exist. In general, the term “virtual reality” refers to a computer simulation of a real or imaginary environment or system that enables a user to perform operations on the simulated system, and shows the effects in real time.

A popular method for capturing images of a real environment to create a virtual reality experience involves pointing a camera at nearby convex lens and taking a picture, thereby capturing a 360 degree panoramic image of the surroundings. Once the picture is converted into digital form, the resulting image can be incorporated into a computer model that can be used to produce a simulation that allows a user to view in all directions around a single static point.

Such 360 degree panoramic images are also widely used to provide potential visitors to hotels, museums, new homes, parks, etc., with a more detailed view of a location than a conventional photograph. Virtual tours, also called “pan tours,” join together (i.e., “stitch together”) a number of pictures to create a “circular picture” that provides a 360 degree field of view. Such circular pictures can give a viewer the illusion of seeing a viewing space in all directions from a designated viewing spot by turning on the viewing spot.

However, known virtual tours typically do not permit the viewer to move from the viewing spot. Furthermore, such systems may use a technique of “zooming” to give the illusion of getting closer to a part of the view, However, the resolution of the picture limits the extent to which this zooming can be done, and the zooming technique still does not allow the viewer to change viewpoints. One producer of these virtual tours is called IPIX (Interactive Pictures Corporation, 1009 Commerce Park Dr., Oak Ridge, Tenn. 37830).

Moving pictures or “movies,” including videos and computer-generated or animated videos, can give the illusion of moving forward in space (such as down a hallway). 360-degree movies are made using two 185-degree fisheye lenses on either a standard 35 mm film camera or a progressive high definition camcorder. The movies are then digitized and edited using standard post-production processes, techniques, and tools. Once the movie is edited, final IPIX hemispherical processing and encoding is available exclusively from IPIX.

IPIX Movies 180-degree are made using a commercially available digital camcorder using the miniDV digital video format and a fisheye lens. Raw video is captured and transferred to a computer via a miniDV deck or camera and saved as an audio video interleave (AVI) file. Using proprietary IPIX software, AVI files are converted to either the RealMedia® format (RealNetworks, Inc., Seattle, Wash.) or to an IPIX proprietary format (180-degree/360-degree) for viewing with the RealPlayer® (RealNetworks, Inc., Seattle, Wash.) or IPIX movie viewer, respectively.

A system and method for producing panoramic video has been devised by FXPAL, the research arm of Fuji Xerox (Foote et al., U.S. Published Application 2003/0063133). Systems and methods are disclosed for generating a video for virtual reality wherein the video is both panoramic and spatially indexed. In embodiments, a video system includes a controller, a database including spatial data, and a user interface in which a video is rendered in response to a specified action. The video includes a plurality of images retrieved from the database. Each of the images is panoramic and spatially indexed in accordance with a predetermined position along a virtual path in a virtual environment.

Unfortunately, the apparatus required by Foote et al. to produce virtual reality videos is prohibitively expensive, the quality of the images are limited, and the method for processing and viewing the virtual reality videos is work intensive.

### SUMMARY OF THE INVENTION

The present invention teaches certain benefits in construction and use which give rise to the objectives described below.

The present invention provides a system for enabling an agent to guide a client through a remote environment. An agent computer system receives input from the agent, uses the input to generate a remote navigation instruction, and provides the remote navigation instruction to a server computer system via a communication network. The remote navigation instruction is indicative of directions of motion and view selected by the agent. The server computer system receives and stores the remote navigation instruction. A client computer system obtains the remote navigation instruction from the server computer system, uses the remote navigation instruction to select image data, and displays an image on a display screen such that the client, when viewing the display screen, experiences a perception of movement through the remote environment in the direction of motion selected by the agent and while looking in the direction of view selected by the agent.

A primary objective of the present invention is to provide a system for enabling an agent to guide a client through a remote environment, the system having advantages not taught by the prior art.

Another objective is to provide a *

A further objective is to provide a *

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a diagram of one embodiment of a computer system used to carry out various methods for simulating movement of a user through a remote environment;

FIG. 2 is a flowchart of a method for simulating movement of a user through a remote environment;

FIGS. 3A-3C in combination form a flowchart of a method for providing images of a remote environment to a user such that the user has the perception of moving through the remote environment;

FIG. 4 is diagram depicting points along multiple paths in a remote environment;

FIG. 5 is a diagram depicting a remote environment wherein multiple parallel paths form a grid network;

FIGS. 6A-6C illustrate a method used to join together edges (i.e., “stitch seams”) of panoramic images such that the user of the computer system of FIG. 1 has a 360 degree field of view of the remote environment;

FIG. 7 shows an image displayed on a display screen of a display device of the computer system of FIG. 1;

FIG. 8 is a diagram of one embodiment of a system that allows an agent to guide a client through a remote environment in an agent-controlled remote navigation mode, and allows the client to guide the agent through the remote environment in a client-controlled remote navigation mode;

FIG. 9 is a diagram of one embodiment of an agent computer system of the system of FIG. 8;

FIG. 10 is a diagram of one embodiment of a server computer system of the system of FIG. 8;

FIG. 11 is a diagram of one embodiment of a client computer system of the system of FIG. 8;

FIG. 12 shows embodiments of several images displayed on a display screen of a display device of the agent computer system of FIG. 9 during operation of the system of FIG. 8 in the agent-controlled remote navigation mode; and

FIG. 13 shows embodiments of several images displayed on a display screen of a display device of the client computer system of FIG. 11 during operation of the system of FIG. 8 in the agent-controlled remote navigation mode.

### DETAILED DESCRIPTION OF THE INVENTION

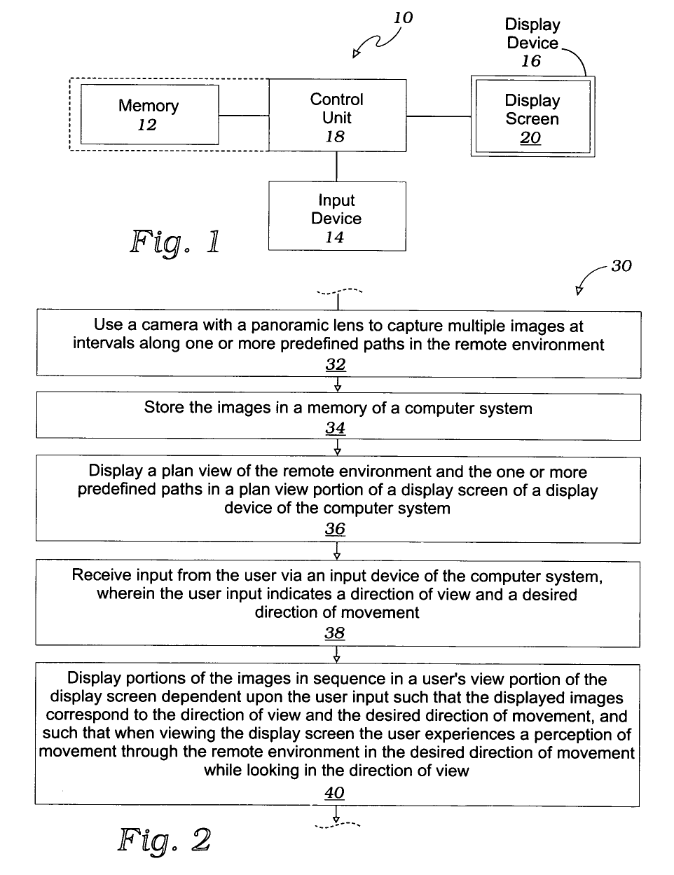

FIG. 1 is a diagram of one embodiment of a computer system 10 used to carry out various methods described below for simulating movement of a user through a remote environment. The remote environment may be, for example, the interior of a building such as a house, an apartment complex, or a museum. In the embodiment of FIG. 1, the computer system 10 includes a memory 12, an input device 14 adapted to receive input from a user of the computer system 10, and a display device 16, all coupled to a control unit 18. The memory 12 may be or include, for example, a hard disk drive, or one or more semiconductor memory devices. As indicated in FIG. 1, the memory 12 may physically located in, and considered a part of, the control unit 18. The input device 14 may be, for example, a pointing device such as a mouse, and/or a keyboard.

In general, the control unit 18 controls the operations of the computer system 10. The control unit 18 stores data in, and retrieves data from, the memory 12, and provides display signals to the display device 16. The display device 16 has a display screen 20. Image data conveyed by the display signals from the control unit 18 determine images displayed on the display screen 20 of the display device 16, and the user can view the images.

FIG. 2 is a flowchart of a method 30 for simulating movement of a user through a remote environment. To aid in the understanding of the invention, the method 30 will be described as being carried out using the computer system 10 of FIG. 1. During a step 32 of the method 30, a camera with a panoramic lens is used to capturing multiple panoramic images at intervals along one or more predefined paths in the remote environment.

The panoramic images may be, for example, 360 degree panoramic images wherein each image provides a 360 degree view around a corresponding point along the one or more predefined paths. Alternately, the panoramic images may be pairs of 180 degree panoramic images, wherein each pair of images provides a 360 degree view around the corresponding point. Each pair of 180 degree panoramic images may be joined at edges (i.e., stitched together) to form a 360 degree view around the corresponding point.

The panoramic images are stored the memory 12 the computer system 10 of FIG. 1 during a step 34. During a step 36, a plan view of the remote environment and the one or more predefined paths are displayed in a plan view portion of the display screen 20 of a display device 16 of FIG. 1. Input is received from the user via the input device 14 of FIG. 1 during a step 38, wherein the user input is indicative of a direction of view and a desired direction of movement. During a step 40, portions of the images are displayed in sequence in a user's view portion of the display screen 20 of the display device 16 of FIG. 1 dependent upon the user input. The portions of the images are displayed such that the displayed images correspond to the direction of view and the desired direction of movement, and such that when viewing the display screen the user experiences a perception of movement through the remote environment in the desired direction of movement while looking in the direction of view.

In one embodiment, each portion of an image it is about one quarter of the image—90 degrees of a 360 degree panoramic image. Each of the 360 degree panoramic images is preferably subjected to a correction process wherein flaws caused by the panoramic camera lens are reduced.

Referring back to FIG. 1, in a preferred embodiment of the computer system 10 the control unit 18 is configured to carry out the steps of 36, 38, and 40 of the method 30 of FIG. 2 under software control. In a preferred embodiment, the software determines coordinates of a visible portion of a first displayed image, and sets a direction variable to either north, south, east, or west.

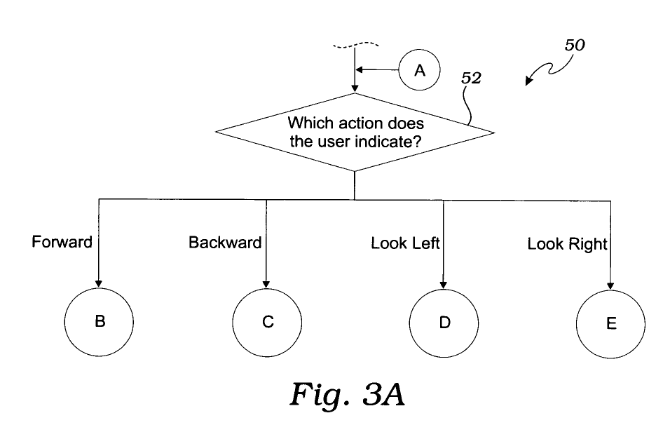

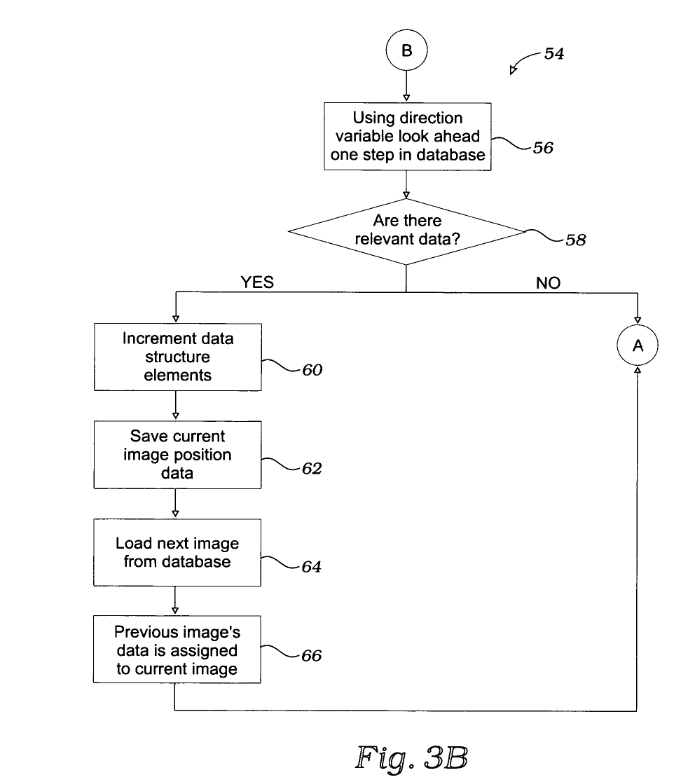

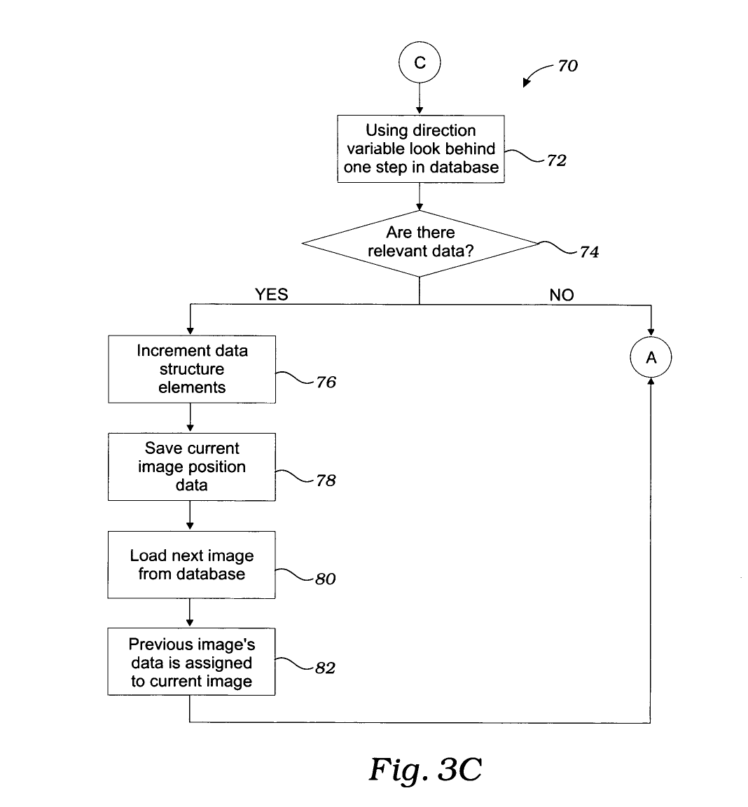

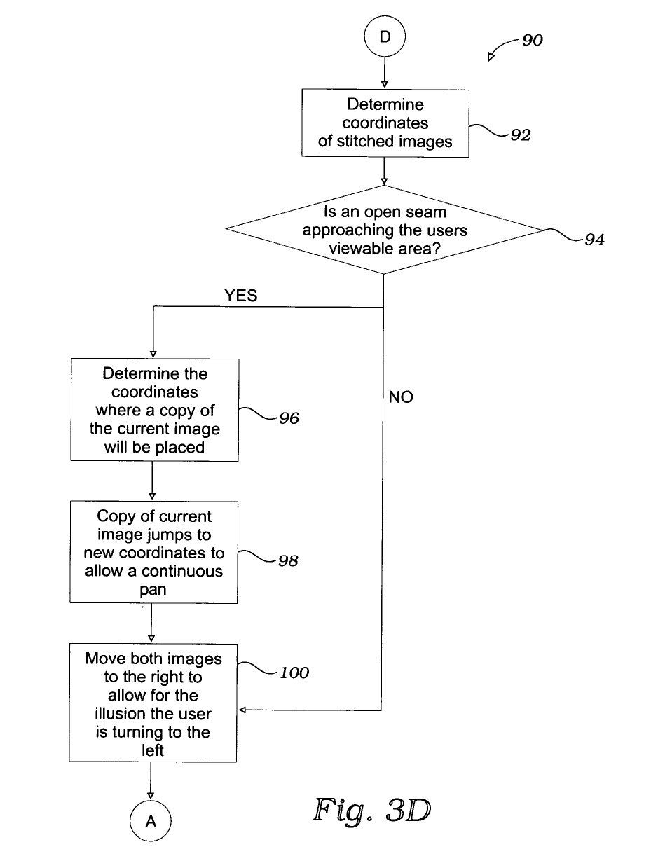

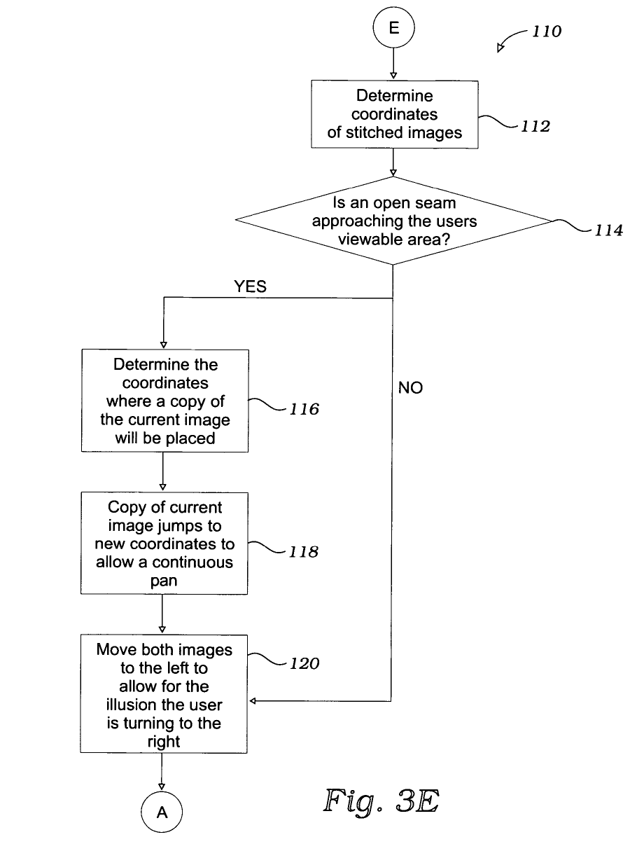

FIGS. 3A-3C in combination form a flowchart of a method 50 for providing images of a remote environment to a user such that the user has the perception of moving through the remote environment. The images are captured (e.g., using a camera with a panoramic lens) at intervals along one or more predefined paths in the remote environment. To aid in the understanding of the invention, the method 50 will be described as being carried out using the computer system 10 of FIG. 1. The method 50 may be incorporated into the method 30 described above.

The images are stored in the memory 12 of the computer system 10, and form an image database. The user can move forward or backward along a selected path through the remote environment, and can look to the left or to the right. A step 52 of the method 50 involves waiting for user input indicating move forward, move backward, look to the left, or look to the right. If the user input indicates the user desires to move forward, a move forward routine 54 of FIG. 3B is performed. If the user input indicates the user desires to move backward, a move backward routine 70 of FIG. 3C is performed. If the user input indicates the user desires to look to the left, a look left routine 90 of FIG. 3C is performed. If the user input indicates the user desires to look to the right, a look right routine 110 of FIG. 3D is performed. One performed, the routines return to the step 52.

FIG. 3B is a flowchart of the move forward routine 54 that simulates forward movement of the user along the selected path in the remote environment. During a step 56, the direction variable is used to look ahead one record in the image database. During a decision step 58, a determination is made as to whether there is an image from an image sequence along the selected path that can be displayed. If such an image exists, steps 60, 62, 64, and 66 are performed. During the step 60, data structure elements are incremented. The data related to the current image's position is saved during the step 62. During the step 64, a next image from the image database is loaded. A previous image's position data is assigned to a current image during a step 66.

During the decision step 58, if no image from an image sequence along the selected path can be displayed, the move forward routine 54 returns to the step 52 of FIG. 3A.

FIG. 3C is a flowchart of the move backward routine 70 that simulates movement of the user in a direction opposite a forward direction along the selected path in the remote environment. During a step 72, the direction variable is used to look behind one record in the image database. During a decision step 74, a determination is made as to whether there is an image from an image sequence along the selected path that can be displayed. If such an image exists, steps 76, 78, 80, and 82 are performed. During the step 76, data structure elements are incremented. The data related to the current image's position is saved during the step 78. During the step 80, a next image from the image database is loaded. A previous image's position data is assigned to a current image during the step 82.

During the decision step 74, if no image from an image sequence along the selected path can be displayed, the move backward routine 70 returns to the step 52 of FIG. 3A.

FIG. 3D is a flowchart of the look left routine 90 that allows the user to look left in the remote environment. During a step 92, coordinates of two images that must be joined (i.e., stitched together) to form a single continuous image are determined. During a decision step 94, a determination is made as to whether an edge of an image (i.e., an open seam) is approaching the user's viewable area. If an open seam is approaching, steps 96, 98, and 100 are performed. If an open seam is not approaching the user's viewable area, only the step 100 is performed.

During the step 96, coordinates where a copy of the current image will be placed are determined. A copy of the current image jumps to the new coordinates to allow a continuous pan during the step 98. During the step 100, both images are moved to the right to create the user perception that the user is turning to the left. Following the step 100, the look left routine 90 returns to the step 52 of FIG. 3A.

FIG. 3E is a flowchart of the look right routine 110 that allows the user to look right in the remote environment. During a step 112, coordinates of two images that must be joined at edges (i.e., stitched together) to form a single continuous image are determined. During a decision step 114, a determination is made as to whether an edge of an image (i.e., an open seam) is approaching the user's viewable area. If an open seam is approaching, steps 116, 118, and 120 are performed. If an open seam is not approaching the user's viewable area, only the step 120 is performed.

During the step 116, coordinates where a copy of the current image will be placed are determined. A copy of the current image jumps to the new coordinates to allow a continuous pan during the step 118. During the step 120, both images are moved to the right to create the user perception that the user is turning to the right. Following the step 120, the look right routine 110 returns to the step 52 of FIG. 3A.

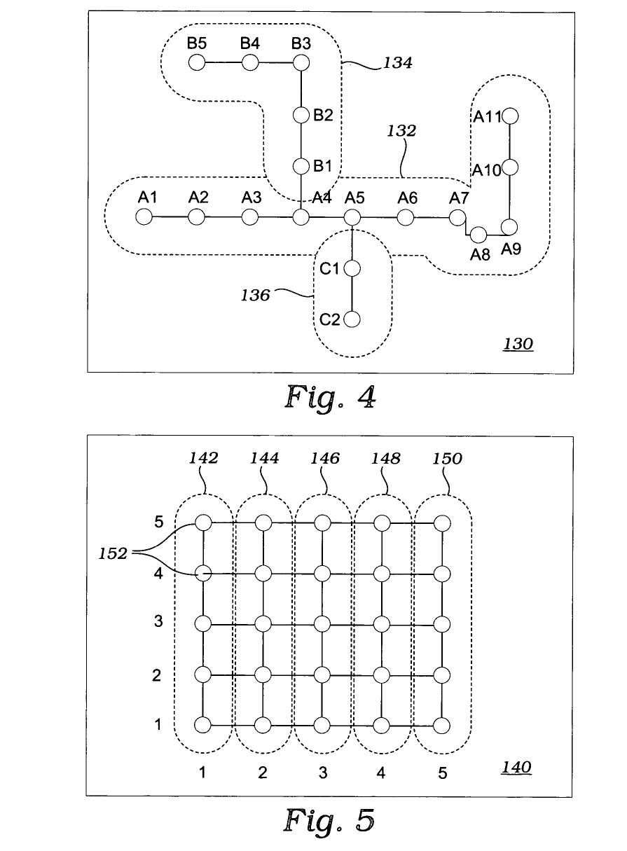

FIG. 4 is diagram depicting points along multiple paths in a remote environment 130. In FIG. 4, the paths are labeled 132, 134, and 136. The points along the paths 132, 134, and 136 are at selected intervals along the paths 132, 134, and 136. Points along the path 132 are labeled A1-A11, points along the path 134 are labeled B1-B5, and points along the path 134 are labeled C1 and C2.

A camera (e.g., with a panoramic lens) is used to capture images at the points along the paths 132, 134, and 136. The images may be, for example, 360 degree panoramic images, wherein each image provides a 360 degree view around the corresponding point. Alternately, the images may be pairs of 180 degree panoramic images, wherein each pair of images provides a 360 degree view around the corresponding point. Each pair of 180 degree panoramic images may be joined at edges (i.e., stitched together) to form a 360 degree view around the corresponding point. Further, each panoramic image captured using a camera with a panoramic lens is preferably subjected to a correction process wherein flaws caused by the panoramic lens are reduced.

The paths 132, 134, and 136, and the points along the paths, are selected to give the user of the computer system 10 of FIG. 1, viewing the images captured at the points along the paths 132, 134, and 136 and displayed in sequence on the display screen 20 of the display device 16, the perception that he or she is moving through, and can navigate through, the remote environment 130.

In FIG. 4, the paths 132 and 134 intersect at point A1, and the paths 132 and 136 intersect at the point A5. Points A1 and A5 are termed “intersection points.” At each intersection of the paths 132, 134, and 136, the user may continue on a current path or switch to an intersecting path. For example, when the user has navigated to the intersection point A1 along the path 132, the user may either continue along the path 132, or switch to the intersection path 134.

FIG. 5 is a diagram depicting a remote environment 140 wherein multiple parallel paths form a grid network. In FIG. 5, the paths are labeled 142, 144, 146, 148, and 150, and are oriented vertically. Points 152 along the paths 142, 144, 146, 148, and 150 are at equal distances along the vertical paths such that they coincide horizontally as shown in FIG. 5. The locations of the points 152 along the paths 142, 144, 146, 148, and 150 thus define a grid pattern, and can be identified using a coordinate system shown in FIG. 5.

As described above, a camera (e.g., with a panoramic lens) is used to capture images at the points 152 along the paths 142, 144, 146, 148, and 150. The images may be, for example, 360 degree panoramic images, wherein each image provides a 360 degree view around the corresponding point. Alternately, the images may be pairs of 180 degree panoramic images, wherein each pair of images provides a 360 degree view around the corresponding point. Each pair of 180 degree panoramic images may be joined at edges (i.e., stitched together) to form a 360 degree view around the corresponding point. Further, each panoramic image captured using a camera with a panoramic lens is preferably subjected to a correction process wherein flaws caused by the panoramic lens are reduced.

The paths 142, 144, 146, 148, and 150, and the points 152 along the paths, are again selected to give the user of the computer system 10 of FIG. 1, viewing the images captured at the points 152 and displayed in sequence on the display screen 20 of the display device 16, the perception that he or she is moving through, and can navigate through, the remote environment 130.

In FIG. 5, a number of horizontal “virtual paths” extend through horizontally adjacent members of the points 152. At each of the points 152, the user may continue vertically on a current path or move horizontally to an adjacent point along a virtual path. For example, when the user has navigated along the path 146 to a middle point located at coordinates 3-3 in FIG. 5 (where the horizontal coordinate is given first and the vertical coordinate is given last), the user may either continue vertically to one of two other points along the path 146, move to the horizontally adjacent point 2-3 along the path 144, or move to the horizontally adjacent point 4-3 along the path 148.

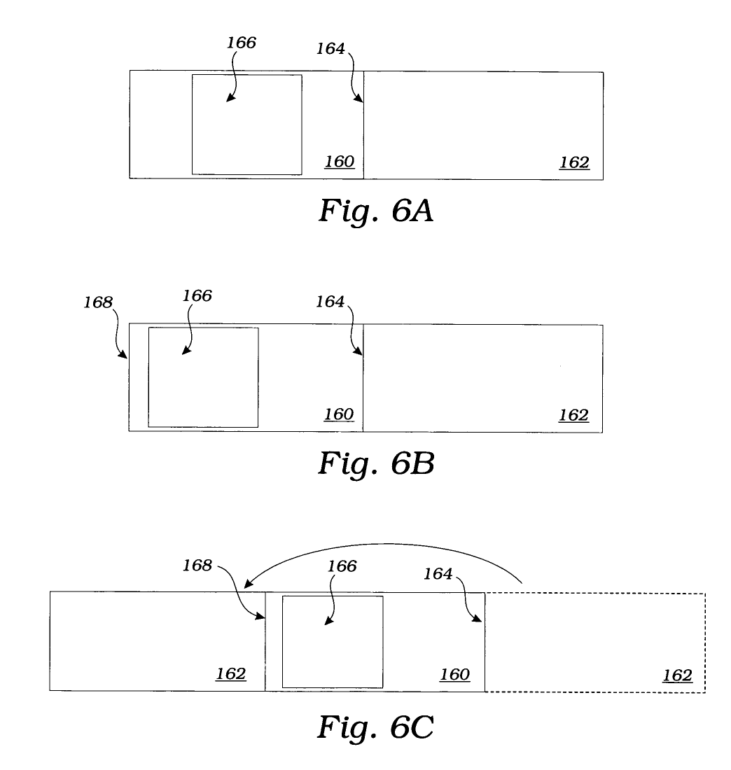

FIGS. 6A-6C illustrate a method used to join together edges (i.e., “stitch seams”) of panoramic images such that the user of the computer system 10 of FIG. 1 has a 360 degree field of view of the remote environment. FIG. 6A is a diagram depicting two panoramic images 160 and 162, wherein a left side edge (i.e., a seam) of the panoramic image 162 is joined to a right side edge 164 of the panoramic image 160. In FIG. 6A, a portion 166 of the panoramic image 160 is currently being presented to the user of the computer system 10 of FIG. 1. In general, when the user changes his or her direction of view such that the portion 166 of the panoramic image 160 currently being presented to the user approaches a side edge of the panoramic image 160, a side edge of another panoramic image is joined to the side edge of the panoramic image 160 such that the user has a 360 degree field of view.

FIG. 6B is the diagram of FIG. 6A wherein the user of the computer system 10 of FIG. 1 has selected to look left, and the portion 166 of the panoramic image 160 currently being presented to the user of the computer system 10 is moving to the left within the panoramic image 160 toward a left side edge 168 of the panoramic image 160. In FIG. 6B, the portion 166 of the panoramic image 160 currently being presented to the user of the computer system 10 is approaching the left side edge 168 of the panoramic image 160.

FIG. 6C is the diagram of FIG. 6C wherein in response to the portion 166 of the panoramic image 160 currently being presented to the user of the computer system 10 approaching the left side edge 168 of the panoramic image 160, wherein the panoramic image 162 is moved from a right side of the panoramic image 160 to a left side of the panoramic image 160, and a right side edge of the panoramic image 162 is joined to the left side edge 168 of the panoramic image 160. In this way, should the portion 166 of the panoramic image 160 currently being presented to the user of the computer system 10 move farther to the left an include the left side edge 168 of the panoramic image 160, the user sees an uninterrupted view of the remote environment.

The panoramic image 160 may advantageously be, for example, a 360 degree panoramic image, and the panoramic image 162 may be a copy of the panoramic image 160. In this situation, only the two panoramic images 160 and 162 are required to give the user of the computer system 10 of FIG. 1 a 360 degree field of view within the remote environment. The method of FIGS. 6A-6C may also be easily extended to use more than two panoramic images each providing a visual range of less than 360 degrees.

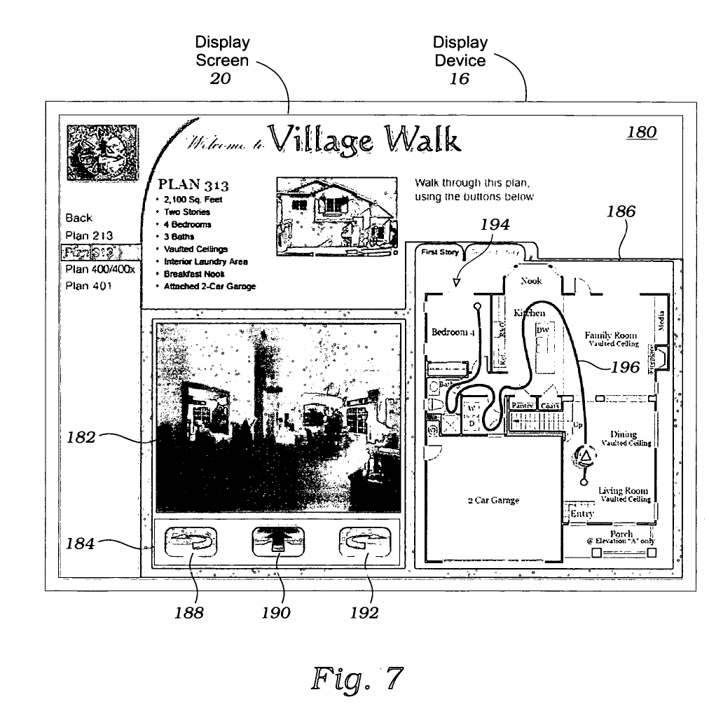

FIG. 7 shows an image 180 displayed on the display screen 20 of the display device 16 of the computer system 10 of FIG. 1. In the embodiment of FIG. 7, the remote environment is a house. The display screen 20 includes user's view portion 182, a control portion 184, and a plan view portion 186. A portion of a panoramic image currently being presented to the user of the computer system 10 is displayed in then user's view portion 182. Selectable control images or icons are displayed in the control portion 184. In FIG. 7, the control icons includes a “look left” button 188, a “move forward” button 190, and a “look right” button 192. In general, the buttons 188, 190, and 192 are activated by the user of the computer system 10 via the input device 14 of FIG. 1. As described above, the input device 14 may be a pointing device such as a mouse, and/or a keyboard.

In FIG. 7, a plan view 194 of the remote environment and a path 196 through the remote environment are displayed in the plan view portion 186 of the display screen 20. The user moves forward along the path 196 by activating the button 190 in the control portion 184 via the input device 14 of FIG. 1. As the activates the button 190 (e.g., by pressing a mouse button while an arrow on the screen controlled by the mouse is positioned over the button 190), portions of panoramic images are displayed sequentially in the user's view portion 182 as described above, giving the user the perception of moving along the path 196. If the user continuously activates the button 190 (e.g., by holding down the mouse button), the portions of panoramic images are displayed sequentially such that the user experiences a perception of continuously moving along the path 196, as if walking along the path 196. As the user moves along the path 196, he or she can look to the left by activating the button 188, or look to the right by activating the button 192. The user has a 360 degree field of view at each point along the path 196.

In the embodiment of FIG. 7, the a control unit 18 of the computer system 10 of FIG. 1 is configured to display the plan view 194 of the remote environment and the path 196 in the plan view portion 186 of the display screen 20 of the display device 16. The control unit 18 is also configured to receive user input via the input device 14 of FIG. 1, wherein the user input indicates a direction of view and a desired direction of movement, and to display portions of panoramic images in sequence in the user's view portion 182 of the display screen 20 dependent upon the user input such that the displayed images correspond to the direction of view and the desired direction of movement. As a result, when viewing the display screen 20, the user experiences a perception of movement through the remote environment in the desired direction of movement while looking in the direction of view.

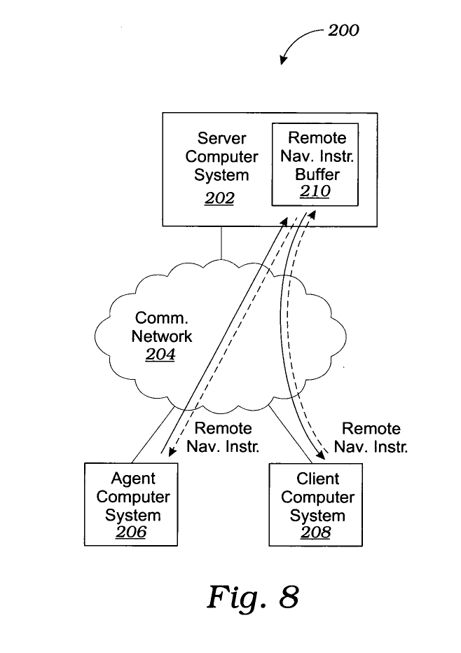

FIG. 8 is a diagram of one embodiment of a system 200 that allows an agent to guide a client through a remote environment in an agent-controlled remote navigation mode, and allows the client to guide the agent through the remote environment in a client-controlled remote navigation mode. As described above, the remote environment may be, for example, the interior of a building such as a house, an apartment complex, or a museum. In the embodiment of FIG. 8, the system 200 includes a server computer system 202, an agent computer system 206, and a client computer system 208 all coupled to a communication network 204. In general, the server computer system 202, the agent computer system 206, and the client computer system 208 all communicate via the communication network 204. The communication network 204 may be or include, for example, a local area network (LAN), a wide area network (WAN), and/or the public switched telephone network (PSTN).

In a preferred embodiment, the communication network 204 includes the Internet, and the server computer system 202 is configured to provide documents, including hypertext markup language (HTML) scripts, in response to requests from the agent computer system 206 and the client computer system 208. That is, the server computer system 202, the agent computer system 206, and the client computer system 208 form part of the Internet, and the server computer system 202 is a World Wide Web (i.e., Web) document server (i.e., a Web server). In general, the agent operates the agent computer system 206, and the client operates the client computer system 208. The system 200 can operate in the agent-controlled navigation mode and the client-controlled navigation mode. In the agent-controlled navigation mode the agent controls navigation through the remote environment, and in the client-controlled navigation mode the client controls navigation through the remote environment.

In the agent-controlled navigation mode, the system 200 carries out a method that allows the agent to guide the client through the remote environment. Input received from the agent via an input device of the agent computer system 206 is used to generate a remote navigation instruction. The agent computer system 206 provides the remote navigation instruction to the server computer system 202 via the communication network 204, and the server computer system 202 stores the remote navigation instruction.

In a preferred embodiment, the remote navigation instruction includes information indicative of a location coordinate and a direction of orientation. The location coordinate describes a current location along one of several predefined paths in the remote environment, and the direction of orientation described a current direction of view about the current location. The navigation instruction may include at least one number that describes a current location in the remote environment according to a predetermined grid coordinate system, and at least one number that describes a direction of view. The navigation instruction may also include a sequence of two or three integer numbers such as “n₁n₂n₃,” wherein the first two numbers n₁ and n₂ form an ordered pair that describes a current location in the remote environment according to a predetermined grid coordinate system (see FIG. 5). The third number n₃ describes a direction of view about the current location. For example, each 45 degree angle about the current location may be assigned a number between 1 and 8. Accordingly, the third number n₃ may be a number between 1 and 8 that describes a corresponding one of the 45 degree angles about the current location direction that defines the current direction of view. Other embodiments of the remote navigation instruction are possible and contemplated. There can also be multiple numbers for directions of view, to add an up and down component to the direction of view. Other specific embodiments are also anticipated, including other arrangements of numbers, with “number” being defined to include any alphanumeric or other symbol or character.

In the agent-controlled navigation mode, the client computer system 208 later obtains the remote navigation instruction from the server computer system 202, and uses the remote navigation instruction to select one of several images of the remote environment. As described above, the selected image may be a portion of a panoramic image. (See FIGS. 6A-6C.) The selected image is displayed on a display screen of the client computer system 208. As a result, the client, viewing the display screen of the client computer system 208, experiences a perception of movement through the remote environment in the direction of motion selected by the agent and while looking in the direction of view selected by the agent.

In the client-controlled navigation mode, the system 200 carries out another method that allows the client to guide the agent through the remote environment. Input received from the client via an input device of the client computer system 208 is used to generate a remote navigation instruction. The client computer system 208 provides the remote navigation instruction to the server computer system 202 via the communication network 204, and the server computer system 202 stores the remote navigation instruction in the remote navigation instruction buffer 210. The agent computer system 206 later obtains the remote navigation instruction from the server computer system 202, and uses the remote navigation instruction to select one of several images of the remote environment. The selected image is displayed on a display screen of the agent computer system 206. As a result, the agent, viewing the display screen of the agent computer system 206, experiences a perception of movement through the remote environment in the direction of motion selected by the client and while looking in the direction of view selected by the client.

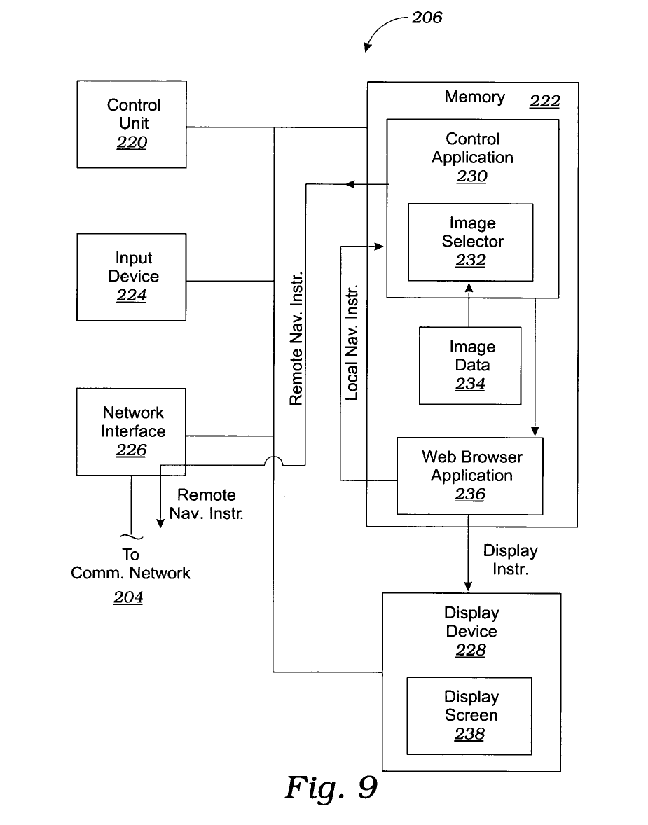

FIG. 9 is a diagram of one embodiment of the agent computer system 206 of FIG. 8. In the embodiment of FIG. 9, the agent computer system 206 includes a control unit 220 coupled to a memory 222, an input device 224, a network interface 226, and a display device 228. The memory 222 may be or include, for example, a hard disk drive, or one or more semiconductor memory devices. The input device 224 may be, for example, a pointing device such as a mouse, and/or a keyboard. In FIG. 9, the display device 228 of the agent computer system 206 includes a display screen 238.

As indicated in FIG. 9, the network interface 226 of the agent computer system 206 is operably coupled to the communication network 204 of FIG. 8. In general, in the agent-controlled remote navigation mode depicted in FIG. 9, the agent computer system 206 is configured to generate the remote navigation instruction dependent upon the input form the agent via the input device 224, and to provide the remote navigation instruction to the server computer system 202 via the network interface 226 and the communication network 204.

In the embodiment of FIG. 9, the memory 222 includes a control application 230 and a Web browser application 236. In the agent-controlled remote navigation mode depicted in FIG. 9, the Web browser application 236 includes a set of computer instructions for receiving the input from the agent via the input device 224, for generating a local navigation instruction dependent upon the input, and for providing the local navigation instruction to the control application 230.

In general, the server computer system 202 is configured to receive the remote navigation instruction, to store the remote navigation instruction in the remote navigation instruction buffer 210, described above and shown in FIG. 8, and to provide the remote navigation instruction stored in the remote navigation instruction buffer 210.

In the agent-controlled remote navigation mode depicted in FIG. 9, the control application 230 includes a set of computer instructions for receiving the local navigation instruction from the Web browser application 236, for generating the remote navigation instruction dependent upon the local navigation instruction, and for providing the remote navigation instruction to the server computer system 202 via the network interface 226 and the communication network 204 of FIG. 1.

In general, the control unit 220 controls the internal operations of the agent computer system 206. The control unit 220 stores data in, and retrieves data from, the memory 222. During operation of the agent computer system 206, the control unit fetches the computer instructions of the control application 230 and the Web browser application 236 from the memory 222, and executes the fetched computer instructions.

In the embodiment of FIG. 9, the memory 222 also includes image data 234. The image data 234 is preferably obtained from the server computer system 202 of FIG. 8 by request via the communication network 204 of FIG. 8 and the network interface 226, and stored in the memory 222. In general, the image data 234 includes data of multiple images captured along one or more predefined paths in the remote environment. The images are preferably panoramic images captured at intervals along the one or more predefined paths. The panoramic images may be, for example, 360 degree panoramic images wherein each image provides a 360 degree view around a corresponding point along the one or more predefined paths. Alternately, the panoramic images may be pairs of 180 degree panoramic images, wherein each pair of images provides a 360 degree view around the corresponding point.

In the embodiment of FIG. 9, the control application 230 includes computer instructions for selecting a portion of the image data 234 corresponding to an image dependent upon the local navigation instruction, for using the selected portion of the image data 234 to produce display information, and for providing the display information to the Web browser application 236. The computer instructions for selecting the portion of the image data 234 dependent upon the local navigation instruction form an image selector 232.

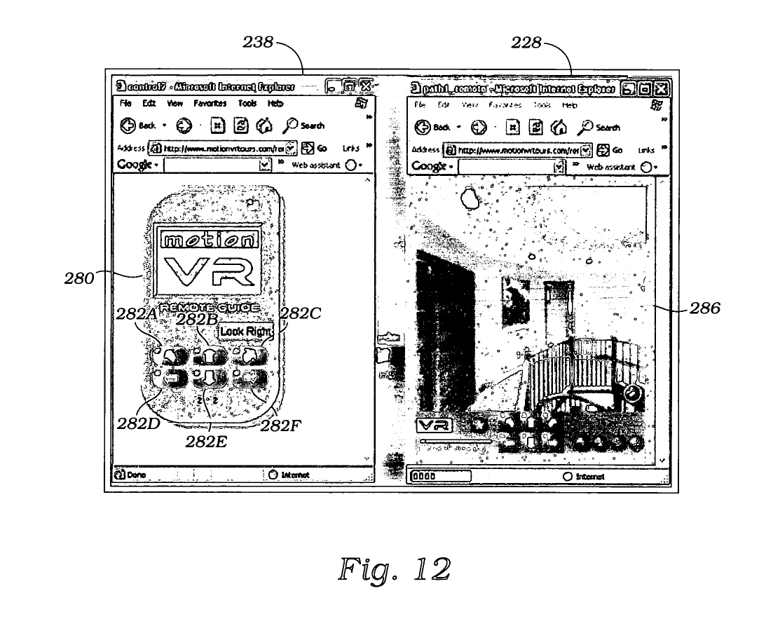

In the agent-controlled remote navigation mode depicted in FIG. 9, the Web browser application 236 includes computer instructions for receiving the display information from the control application 230, for using the display information to generate display instructions, and for providing the display instructions to the display device 228 such that a navigation control panel is displayed in a first portion of the display screen 238 of the display device 228, and the image displayed on the display screen of the client computer system 208 is also displayed in a second portion of the display screen 238 of the display device 228. (See FIG. 12.)

As described in more detail below, in the agent-controlled remote navigation mode depicted in FIG. 9, the navigation control panel displayed in the first portion of the display screen 238 of the display device 228 includes multiple selectable control images or icons commonly known as buttons. Each button corresponds to a different and optional direction of motion and/or view within the remote environment. By activating the buttons of the navigation control panel via the input device 224, the agent is able to guide the client through the remote environment. The image displayed in the second portion of the display screen 238 of the display device 228 depicts the currently selected directions of motion and view, and greatly helps the agent select new directions of motion and view within the remote environment.

In the client-controlled navigation mode, the client computer system 208 of FIG. 8 generates the remote navigation instruction and provides the remote navigation instruction to the server computer system 202. In the client-controlled navigation mode, the remote navigation instruction is indicative of a location selected by the client and a direction of view selected by the client. The control application 230 of the agent computer system 206 obtains the remote navigation instruction from the server computer system 202 via the communication network 204, and the image selector 234 of the control application 230 selects a portion of the image data 234 corresponding to an image dependent upon the received remote navigation instruction. The control application 230 uses the selected portion of the image data 234 to produce display information, and provides the display information to the Web browser application 236. The Web browser application 236 receives the display information from the control application 230, uses the display information to generate display instructions, and provides the display instructions to the display device 228 such that an image displayed on the display screen of the client computer system 208 is also displayed on the display screen 238 of the display device 228. As a result, the client is able to guide the agent through the remote environment. The agent, viewing the display screen 238 of the agent computer system 206, experiences a perception of movement through the remote environment in the direction of motion selected by the client and while looking in the direction of view selected by the client.

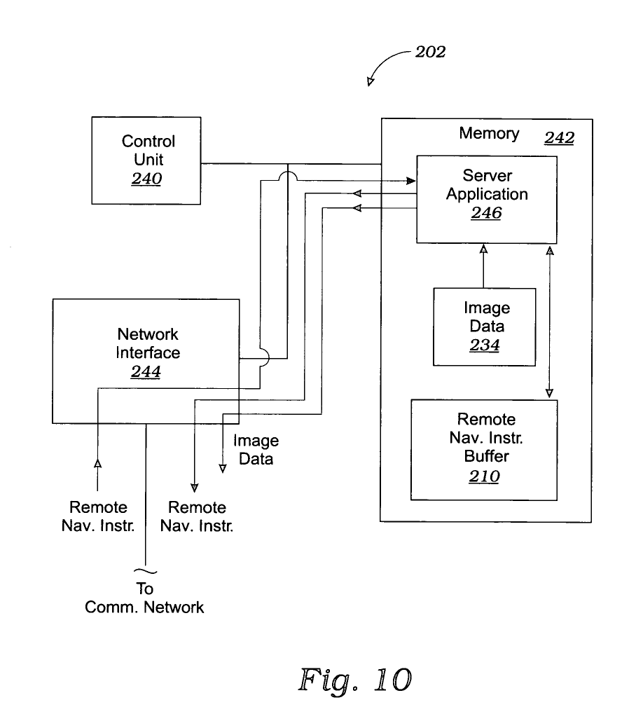

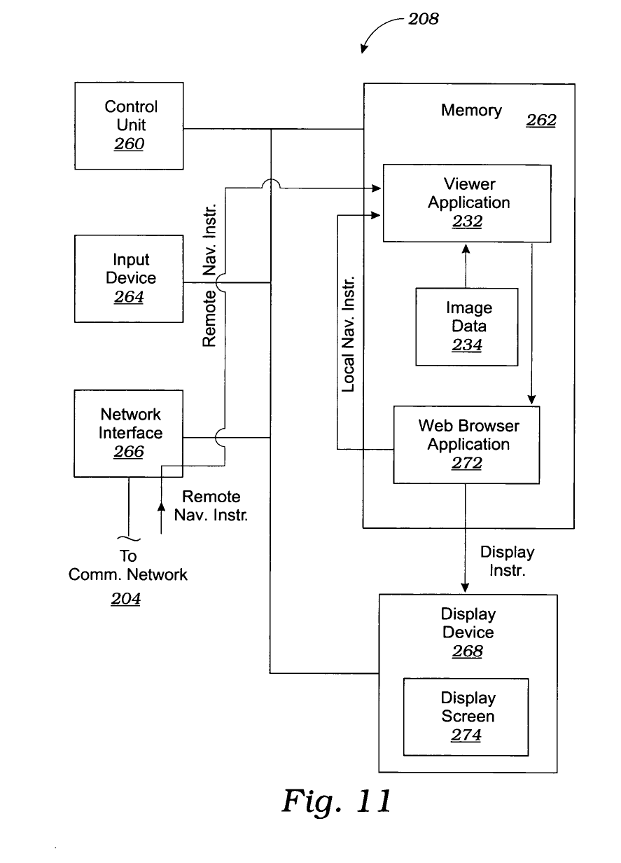

FIG. 10 is a diagram of one embodiment of the server computer system 202 of FIG. 8. In the embodiment of FIG. 8, the server computer system 202 includes a control unit 240 coupled to a memory 242 and a network interface 244. The memory 242 may be or include, for example, a hard disk drive, or one or more semiconductor memory devices. As indicated in FIG. 10, the network interface 244 is operably coupled to the communication network 204 of FIG. 8.

In the embodiment of FIG. 10, the memory 242 of the server computer system 202 includes a server application 246, the image data 234 described above, and a remote navigation instruction buffer 210. In general, the server computer system 202 is configured to provide the image data 234 in response to a request for the image data 234. In the agent-controlled remote navigation mode depicted in FIG. 10, the server computer system 202 is also configured to receive the remote navigation instruction from the agent computer system 206 via the communication network 204 of FIG. 8 and network interface 244, and to store the remote navigation instruction in the remote navigation instruction buffer 210. The server computer system 202 is also configured to retrieve the stored remote navigation instruction from the remote navigation instruction buffer, and to provide the remote navigation via the network interface 244 and the communication network 204 in response to a request for the remote navigation instruction.

In the embodiment of FIG. 10, the server application 246 includes computer instructions for providing the image data 234 in response to a request for the image data. In the agent-controlled remote navigation mode depicted in FIG. 10, the server application 246 also includes computer instructions for receiving the remote navigation instruction from the agent computer system 206 via the communication network 204 of FIG. 8 and the network interface 244, and for storing the remote navigation instruction in the remote navigation instruction buffer 210. The server application 246 also includes computer instructions for retrieving the remote navigation instruction from the remote navigation instruction buffer 210 and providing the remote navigation via the network interface 244 and the communication network 204 in response to a request for the remote navigation instruction.

In general, the control unit 240 controls the internal operations of the server computer system 202. The control unit 240 stores data in, and retrieves data from, the memory 242. During operation of the server computer system 202, the control unit 240 fetches the computer instructions of the server application 246 from the memory 242 and executes the fetched computer instructions.

FIG. 11 is a diagram of one embodiment of the client computer system 208 of FIG. 8. In the embodiment of FIG. 11, the client computer system 208 includes a control unit 260 coupled to a memory 262, an input device 264, a network interface 266, and a display device 268. The memory 262 may be or include, for example, a hard disk drive, or one or more semiconductor memory devices. The input device 264 may be, for example, a pointing device such as a mouse, and/or a keyboard. As indicated in FIG. 11, the network interface 266 of the client computer system 208 is operably coupled to the communication network 204 of FIG. 8. In FIG. 11, the display screen of the client computer system 208 is labeled 274, and the display device 268 includes the display screen 274.

In the embodiment of FIG. 11, the memory 262 includes the image data 234. The image data 234 is preferably obtained from the server computer system 202 of FIG. 8 by request via the network interface 266 and the communication network 204 of FIG. 8, and stored in the memory 262.

In the agent-controlled remote navigation mode depicted in FIG. 11, the client computer system 208 is configured to obtain the remote navigation instruction from the server computer system 202 of FIG. 8 via the network interface 266 and the communication network 204 of FIG. 8, to select a portion of the image data 234 dependent upon the remote navigation instruction, to use the selected portion of the image data 234 to produce display instructions, and to provide the display instructions to the display device 268. As described above, the remote navigation instruction is indicative of a direction of motion selected by the agent and a direction of view selected by the agent. The selected portion of the image data 234 corresponds to an image conforming to the direction of motion selected by the agent and the direction of view selected by the agent. As described above, the image may be a portion of a panoramic image. (See FIGS. 6A-6C.)

For example, in the agent-controlled remote navigation mode, the client computer system 208 may poll the server computer system 202 frequently to determine if a new remote navigation instruction has been stored by the server computer system 202. The client computer system 208 may include, for example, current location and orientation data stored in the memory 222. The client computer system 208 may use the remote navigation instruction obtained from the server computer system 202 to modify the current location and orientation data.

In the embodiment of FIG. 11, the memory 222 also includes a viewer application 270 and a Web browser application 272. In the agent-controlled remote navigation mode depicted in FIG. 11, the viewer application 270 includes a set of computer instructions for obtaining the remote navigation instruction from the server computer system 202 via the network interface 266 and the communication network 204 of FIG. 8, for selecting the portion of the image data 234 dependent upon the remote navigation instruction, for using the selected portion of the image data 234 to produce display information, and for providing the display information to the Web browser application 272.

In the embodiment of FIG. 11, the Web browser application 272 includes a set of computer instructions for receiving the display information from the viewer application 270, using the display information to generate display instructions, and for providing the display instructions to the display device 268. As a result, in the agent-controlled remote navigation mode depicted in FIG. 11, images are displayed on the display screen 274 of the display device 268 in succession such that the client, viewing the display screen 274, experiences a perception of movement through the remote environment in the direction of motion selected by the agent and while looking in the direction of view selected by the agent.

In general, the control unit 260 controls the internal operations of the client computer system 208. The control unit 260 stores data in, and retrieves data from, the memory 262. During operation of the client computer system 208, the control unit fetches the computer instructions of the viewer application 270 and the Web browser application 272 from the memory 262, and executes the fetched computer instructions.

In the embodiment of FIG. 11, the client computer system 208 also supports a local navigation mode. The Web browser application 272 also includes computer instructions for receiving input from the client via the input device 264, for generating a local navigation instruction dependent upon the input, and for providing the local navigation instruction to the viewer application 270. The viewer application 270 also includes computer instructions for receiving the local navigation instruction from the Web browser application 236, and for selecting between the local navigation instruction and the remote navigation instruction.

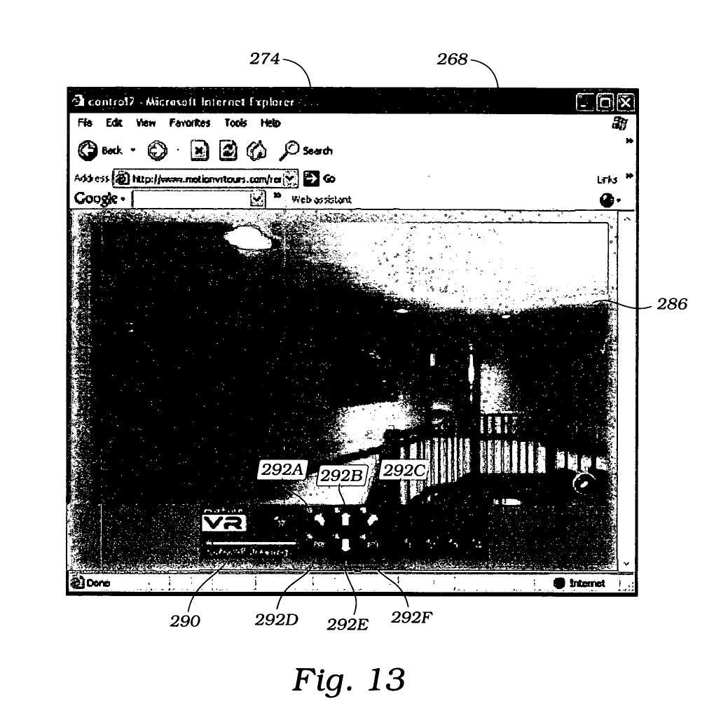

For example, a navigation control panel may be displayed in a first portion of the display screen 274 of the display device 268. The navigation control panel may include multiple buttons as described above. Some of the buttons may correspond to different and optional directions of motion and/or view within the remote environment, allowing the client to navigate the remote environment without the help of the agent. One of the buttons may be a remote navigation button that, when activated by the client via the input device 264, initiates the agent-controlled remote navigation mode and permits the agent to guide the client through the remote environment. An image displayed in a second portion of the display screen 274 may depict a currently selected direction of motion and/or view within the remote environment. (See FIG. 13.)

In the client-controlled remote navigation mode, the client computer system 208 is configured to generate the remote navigation instruction dependent upon input form the client via the input device 264, and to provide the remote navigation instruction to the server computer system 202. The viewer application 270 generates the remote navigation instruction dependent upon the local navigation instruction received from the Web browser application 272, and provides the remote navigation instruction to the server computer system 202 via the network interface 266 and the communication network 204.

FIGS. 12 and 13 show embodiments of images displayed on the display screen 238 of the agent computer system 206 of FIG. 9, and the display screen 274 of the client computer system 208 of FIG. 11, during operation of the system 200 of FIG. 8. In the embodiments of FIGS. 12 and 13, the remote environment is an interior of a house, and the agent is guiding the client through the interior of the house. It is noted that other environments and commercial applications may also be adapted by one skilled in the art.

FIG. 12 shows embodiments of several images displayed on the display screen 238 of the display device 228 of the agent computer system 206 of FIG. 9 during operation of the system 10 of FIG. 8 in the agent-controlled remote navigation mode. In the agent-controlled remote navigation mode depicted in FIG. 12, the navigation control panel, described above and labeled 280 in FIG. 12, is an image displayed in a left portion of the display screen 238. The navigation control panel 280 includes multiple buttons 282A-282F. Each of the buttons 282A-282F has an arrow corresponding to a different and optional direction of motion and/or view within the remote environment. By activating the buttons 282A-282F of the navigation control panel 280 via the input device 224 of FIG. 9, the agent is able to select the direction of motion and the direction of view, thereby guiding the client through the remote environment.

For example, in the embodiment of FIG. 12, the button 282A corresponds to a change (e.g., a 45 degree change) in the direction of view to the left. The button 282B corresponds to movement (e.g., to a next predetermined point) in a forward direction. The button 282C corresponds to a change (e.g., a 45 degree change) in the direction of view to the right. The button 282D corresponds to movement (e.g., to a next predetermined point) to a right side (without changing the direction of view). The button 282E corresponds to movement (e.g., to a next predetermined point) in a backward direction (opposite the forward direction). The button 282F corresponds to movement (e.g., to a next predetermined point) to a left side (without changing the direction of view).

In the agent-controlled remote navigation mode depicted in FIG. 12, an image 286 displayed in a right portion of the display screen 238 of the agent computer system 206 of FIG. 9 shows a view of the remote environment (i.e., the interior of the house) that depicts the directions of motion and view currently selected by the agent. As described above, the image 286 is also displayed on the display screen 274 of the client computer system 208 (See FIGS. 11 and 13). Displaying the image 286 in a portion of the display screen 238 of the agent computer system 206 greatly helps the agent select new directions of motion and view within the remote environment.

FIG. 13 shows embodiments of several images displayed on the display screen 274 of the display device 268 of the client computer system 208 of FIG. 11 during operation of the system 10 of FIG. 8 in the agent-controlled remote navigation mode. In the agent-controlled remote navigation mode depicted in FIG. 13, the image 286 is displayed central portion of the display screen 274, and shows the view of the remote environment (i.e., the interior of the house) that depicts the directions of motion and view currently selected by the agent. As the client views the display screen 274, the client experiences a perception of movement through the remote environment (i.e., the interior of the house) in the direction of motion selected by the agent and while looking in the direction of view selected by the agent

In the embodiment of FIG. 13, a navigation control panel 290 is an image displayed in a lower portion of the display screen 274. The navigation control panel 290 includes multiple buttons 292A-292F. Some of the buttons 292A-292F have an arrow corresponding to a different and optional direction of motion and/or view within the remote environment. In a local navigation mode of the client computer system 208 of FIG. 11, the client selects a direction of motion and a direction of view by activating the buttons 292A-292F of the navigation control panel 290 via the input device 264 of FIG. 11, thereby navigating through the remote environment without the help of the agent.

For example, in the embodiment of FIG. 13, the button 292A corresponds to a change (e.g., a 45 degree change) in the direction of view to the left. The button 292B corresponds to movement (e.g., to a next predetermined point) in a forward direction. The button 292C corresponds to a change (e.g., a 45 degree change) in the direction of view to the right. The button 292D corresponds to movement (e.g., to a next predetermined point) to a right side (without changing the direction of view). The button 292E corresponds to movement (e.g., to a next predetermined point) in a backward direction (opposite the forward direction). The button 292F corresponds to movement (e.g., to a next predetermined point) to a left side (without changing the direction of view).

The navigation control panel 290 may also include a remote navigation button that activates the agent-controlled remote navigation mode. In the agent-controlled remote navigation mode, the buttons 292A-292F that allow the client to select the direction of motion and the direction of view may be deactivated, and the agent, remote from the client and operating the agent computer system 206 of FIG. 8, may be permitted to select the direction of motion and the direction of view depicted in the image 286 displayed in the central portion of the display screen 274 of the client computer system 208 of FIG. 8, thereby allowing the agent to guide the client through the remote environment.

Other features may be added to this basic system. For example, a communications link, either through standard phone lines, VoIP, instant messaging, or other method, may enable the agent and the client to communicate as the agent leads the client through the environment. The client could also resume control, lead the agent to a specific location, to ask additional questions. Such an interactive, client controlled experience enables the client to quickly and easily receive a guided tour of a remote, virtual environment, through a single computer system.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A system allowing an agent to guide a client through a remote environment, the system comprising:
a server computer system, an agent computer system, and a client computer system coupled via a communication network;
wherein the agent computer system is adapted to receive input from the agent, to generate a remote navigation instruction dependent upon the input, and to provide the remote navigation instruction to the server computer system via the communication network;
wherein the server computer system is adapted to receive the remote navigation instruction from the agent computer system via the communication network and to store the remote navigation instruction; and
wherein the client computer system comprises a display screen and is adapted to obtain the remote navigation instruction from the server computer system via the communication network, to select image data corresponding to an image dependent upon the remote navigation instruction, and to display the image on the display screen of the client computer system.

2. The system as recited in claim 1, wherein the remote navigation instruction is indicative of a location selected by the agent and a direction of view selected by the agent.

3. The system as recited in claim 2, wherein the navigation instruction comprises at least at least one number defines the location selected by the agent according to a predetermined grid coordinate system, and wherein at least one number defines the direction of view selected by the agent.

4. The system as recited in claim 2, wherein the client computer system is adapted to display the image on the display screen of the client computer system such that the client, when viewing the display screen, experiences a perception of movement through the remote environment in the direction of motion selected by the agent and while looking in the direction of view selected by the agent.

5. The system as recited in claim 1, wherein the agent computer system comprises a network interface operably coupled to the communication network, and wherein the agent computer system is adapted to generate the remote navigation instruction dependent upon the input and to provide the remote navigation instruction to the server computer system via the network interface.

6. The system as recited in claim 1, wherein the agent computer system comprises:
a control unit;
an input device coupled to the control unit;
a network interface coupled to the control unit and operably coupled to the communication network;
a memory coupled to the control unit and comprising a control application and a Web browser application;
wherein the Web browser application comprises a first set of computer instructions for receiving the input from the agent via the input device, for generating a local navigation instruction dependent upon the input, and for providing the local navigation instruction;
wherein the control application comprises a second set of computer instructions for receiving the local navigation instruction from the Web browser application, for generating the remote navigation instruction dependent upon the local navigation instruction, and for providing the remote navigation instruction to the server computer system via the network interface; and
wherein the control unit is adapted to fetch the first and second sets of computer instructions from the memory, and to execute the fetched first and second sets of computer instructions.

7. The system as recited in claim 6, wherein the second set of computer instructions of the control application includes computer instructions for selecting a portion of the image data corresponding to an image dependent upon the local navigation instruction, for using the selected portion of the image data to produce display information, and for providing the display information to the Web browser application.

8. The system as recited in claim 6, wherein the agent computer system comprises a display device coupled to the control unit and having a display screen, and wherein the first set of computer instructions of the Web browser application includes computer instructions for receiving the display information from the control application, for using the display information to generate display instructions, and for providing the display instructions to the display device of the agent computer system such that a navigation control panel is displayed in a first portion of the display screen of the display device of the agent computer system, and the image displayed on the display screen of the client computer system is also displayed in a second portion of the display screen of the display device of the agent computer system.

9. The system as recited in claim 1, wherein the server computer system comprises:
a network interface operably coupled to the communication network;
a memory comprising image data and a remote navigation instruction buffer; and
wherein the server computer system is adapted to provide the image data in response to a request for the image data, to receive the remote navigation instruction from the agent computer system via the network interface and to store the remote navigation instruction in the remote navigation instruction buffer, and to retrieve the remote navigation instruction from the remote navigation instruction buffer and to provide the remote navigation in response to a request for the remote navigation instruction.

10. The system as recited in claim 1, wherein the server computer system comprises:
a control unit;
a network interface coupled to the control unit and operably coupled to the communication network;
a memory coupled to the control unit and comprising a server application, image data, and a remote navigation instruction buffer;
wherein the image data comprises data of a plurality of images;
wherein the remote navigation instruction buffer is adapted to store the remote navigation instruction;
wherein the server application comprises a plurality of computer instructions for providing the image data in response to a request for the image data, for receiving the remote navigation instruction from the agent computer system via the network interface and storing the remote navigation instruction in the remote navigation instruction buffer, and for retrieving the remote navigation instruction from the remote navigation instruction buffer and providing the remote navigation in response to a request for the remote navigation instruction; and
wherein the control unit is adapted to fetch the computer instructions from the memory and to execute the computer instructions.

11. The system as recited in claim 1, wherein the client computer system comprises:
a network interface coupled to the control unit and operably coupled to the communication network;
a display device coupled to the control unit and having the display screen;
a memory comprising image data; and
wherein the client computer system is adapted to obtain the remote navigation instruction from the server computer system, to select a portion of the image data dependent upon the remote navigation instruction, to use the selected portion of the image data to produce display instructions, and to provide the display instructions to the display device.

12. The system as recited in claim 11, wherein the selected portion of the image data corresponds to an image conforming to the direction of motion selected by the agent and the direction of view selected by the agent.

13. The system as recited in claim 1, wherein the client computer system comprises:
a control unit;
an input device coupled to the control unit;
a network interface coupled to the control unit and operably coupled to the communication network;
a display device coupled to the control unit and having the display screen;
a memory coupled to the control unit and comprising a viewer application, image data, and a Web browser application;
wherein the viewer application comprises a first set of computer instructions for obtaining the remote navigation instruction from the server computer system, for selecting a portion of the image data corresponding to an image dependent upon the remote navigation instruction, for using the selected portion of the image data to produce display information; and for providing the display information to the Web browser application;
wherein the Web browser application comprises a second set of computer instructions for receiving the display information from the viewer application, using the display information to generate display instructions, and for providing the display instructions to the display device; and
wherein the control unit is adapted to fetch the first and second sets of computer instructions from the memory, and to execute the fetched first and second sets of computer instructions.

14. The system as recited in claim 13, wherein the selected portion of the image data corresponds to an image conforming to the direction of motion selected by the agent and the direction of view selected by the agent.

15. A system allowing an agent to guide a client through a remote environment in a first remote navigation mode, and the client to guide the agent through the remote environment in a second remote navigation mode, the system comprising:
a server computer system, an agent computer system, and a client computer system coupled via a communication network;
wherein the agent computer system is operated by the agent and comprises a display screen;
wherein the client computer system is operated by the client and comprises a display screen;
wherein the server computer system is adapted to receive a remote navigation instruction via the communication network, to store the remote navigation instruction, and to provide the stored remote navigation instruction;
wherein in the first remote navigation mode the agent computer system is adapted to receive input from the agent, to generate a remote navigation instruction dependent upon the input, and to provide the remote navigation instruction to the server computer system via the communication network;
wherein in the second remote navigation mode the agent computer system is adapted to receive the stored remote navigation instruction from the server computer system via the communication network, to select image data corresponding to an image dependent upon the received remote navigation instruction, and to display the image on the display screen of the agent computer system;
wherein in the first remote navigation mode the client computer system is adapted to receive the stored remote navigation instruction from the server computer system via the communication network, to select image data corresponding to an image dependent upon the received remote navigation instruction, and to display the image on the display screen of the client computer system; and
wherein in the second remote navigation mode the client computer system is adapted to receive input from the client, to generate a remote navigation instruction dependent upon the input, and to provide the remote navigation instruction to the server computer system via the communication network.

16. The system as recited in claim 15, wherein in the first remote navigation mode the remote navigation instruction is indicative of a location selected by the agent and a direction of view selected by the agent.

17. The system as recited in claim 16, wherein in the first remote navigation mode the client computer system is adapted to display the image on the display screen of the client computer system such that the client, when viewing the display screen of the client computer system, experiences a perception of movement through the remote environment in the direction of motion selected by the agent and while looking in the direction of view selected by the agent.

18. The system as recited in claim 15, wherein in the second remote navigation mode the remote navigation instruction is indicative of a location selected by the client and a direction of view selected by the client.

19. The system as recited in claim 18, wherein in the second remote navigation mode the agent computer system is adapted to display the image on the display screen of the agent computer system such that the agent, when viewing the display screen of the agent computer system, experiences a perception of movement through the remote environment in the direction of motion selected by the client and while looking in the direction of view selected by the client.
